(19) United States
(12) Patent Application Publication
(10) Pub. No.: US 2011/0200244 A1
(43) Pub. Date: Aug. 18, 2011

(54) METHOD, APPARATUS AND PHANTOM FOR MEASURING AND CORRECTING TOMOGRAM ERRORS

(75) Inventors: Sharon Ann Ashton, Bristol (GB); Hugo George Derrick, Stroud (GB); James David Mortimer, Stroud (GB)

(73) Assignee: RENISHAW (IRELAND) LIMITED, Swords, Dublin (IE)

(21) Appl. No.: 13/124,952

(22) PCT Filed: Nov. 13, 2009
(86) PCT No.: PCT/GB2009/002659

§ 371 Date: Apr. 19, 2011

(30) Foreign Application Priority Data
Nov. 13, 2008 (GB) 0820839.9

(51) Int. Cl. G06K 9/00

(52) U.S. Cl. 382/131

(57) ABSTRACT

A tomogram taken on an imaging path of a tomograph is corrected by using sets of tomogram correction data for neighbouring positions on that path, in an interpolative process. An error map of a tomograph is built up by comparing tomograms of a phantom with the expected appearance of the phantom at the tomogram positions. Also provided is a phantom having a body with one or more imaging fluid receptacles formed therein.

### FIELD OF THE INVENTION

The invention relates to the field of tomography.

### BACKGROUND

In tomography, a device called a tomograph takes a series of 2D images, called tomograms, at various positions within an object. Often, these tomograms are combined using mathematical techniques to produce a 3D image, called a polytomogaph, of the internal structure of the object. A series of tomograms that are combined into a polytomograph of a target object are captured at different positions along an imaging path.

Typically, the imaging path is an axis extending into the target object and the tomograms are images of 2D planes (slices) within the target object, each plane lying perpendicular to the imaging path and intersecting the imaging path at a respective capture position. Such a scheme is shown in FIG. 1, which illustrates three planes 28, 30 and 32 in which tomograms are captured. The planes 28, 30 and 32 are parallel to one another and all lie perpendicular to axis 34. The points of intersection of planes 28, 30 and 32 with axis 34 are labelled 36, 38 and 40, respectively. In this context, the imaging path is represented by the axis 34 and the capture positions are represented by intersection points 36, 38 and 40.

In another common configuration, the tomograms are images of 2D planes (slices) within the target object, with a common axis lying in each plane and the planes being related to each other by lying at different rotations about the axis. In this case, the imaging path is a rotational sweep about the axis and the capture positions are the specific rotations about this axis at which tomograms are captured. Such a scheme is illustrated in FIG. 2, which shows three planes 42, 44 and 46 in which tomograms are captured. An axis 48 lies in all three of the planes 42, 44 and 46. The planes 42, 44 and 46 are positioned at different rotations about the axis 48 such that rotational sweep about this axis defines the imaging path and the capture positions are the specific rotations about this axis at which the planes 42, 44 and 46 lie.

Magnetic Resonance Imaging (MRI) scanners and Computed Tomography (CT) scanners are examples of tomographs that use non-ionising and ionising radiation, respectively. Typically, an MRI scanner has imaging paths of the kind shown in FIG. 1 and a CT scanner has an imaging path of the kind shown in FIG. 2.

Images produced by a tomograph inevitably contain some distortion. Consider, for example, an MRI polytomograph of a human brain produced by a modern MRI scanner. Typically, the position of a physical feature of the brain in such a tomograph will differ from the feature's actual position in the brain by an error of ±2 millimetres. This can be a considerable drawback in surgical procedures where high accuracy is required, for example when using an MRI polytomograph to position an electrode in a human brain to treat Parkinson's disease.

It is known to calibrate a tomograph by using the tomograph to produce tomograms of a calibration object of known shape and dimensions. Such calibration objects are often called phantoms.

A paper “Detection and correction of geometric distortion in 3D CT/MR images”, Breeuwer et al, CARS '99, Jun. 23-26, 1999, Paris France, describes a calibration method using such phantoms. The phantom may comprise an arrangement of aluminium rods, or it may comprise an array of spaced perspex (acrylic) spheres surrounded by an imaging solution (copper sulphate). JP 2006-141782A describes phantoms in which spherical beads containing an imaging fluid are located in a spaced arrangement in holes or passages in an acrylic plate or block.

Such arrangements can suffer from uncertainty in the shape, dimensions or positioning of the rods or spheres, which leads to uncertainty in the calibration. In the case of spheres, it is also difficult to be certain whether a tomogram of the phantom passes through the centres of the spheres.

The Breeuwer et al paper also describes a distortion correction method in which a 3D distortion transformation is produced from the phantom, and later used to correct patient scans. This is a complex manipulation of data from the whole imaging volume, and is not adapted to the 2D tomogram slices taken in actual practice.

### SUMMARY OF THE INVENTION

According to one aspect, the invention provides a method of correcting a tomogram captured at a capture position located along an imaging path of a tomograph, the method comprising identifying amongst a plurality of survey positions along the imaging path at least two survey positions that neighbour the capture position, and interpolating a corrected form for the tomogram on the basis of sets of tomogram correction data for the identified survey positions and the relative distances from the capture position to each of the identified survey positions, wherein each survey position has a respective set of tomogram correction data for correcting a tomogram captured by the tomograph at that position on the path.

The invention also relates to apparatus for correcting a tomogram captured at a capture position located along an imaging path of a tomograph, the apparatus comprising means for identifying amongst a plurality of survey positions along the imaging path at least two survey positions that neighbour the capture position, and means for interpolating a corrected form for the tomogram on the basis of the sets of tomogram correction data for the identified survey positions and the relative distances from the capture position to each of the identified survey positions, wherein each survey position has a respective set of tomogram correction data for correcting a tomogram captured by the tomograph at that position on the path.

Thus, the invention provides a way of correcting a tomogram based on error data collected along the imaging path to which the tomogram relates.

In certain embodiments, the interpolation of said corrected form utilises tomogram correction data from only two identified survey positions, one on each side of the capture position. In other embodiments however, the interpolation may be more complex and may also involve correction data from one or more survey positions that are not the nearest neighbours to the capture position of the tomogram to be corrected. Indeed, it may sometimes be possible to extrapolate from a plurality of survey positions all on one side of the capture position, and the references in the appended claims to interpolating a corrected form should be interpreted accordingly.

In certain embodiments, the interpolation of the corrected form of the tomogram involves interpolating a set of tomogram correction data for the capture position and applying the interpolated set of tomogram correction data to the tomogram. In other embodiments however, the interpolation of the corrected form of the tomogram involves applying the set of tomogram correction data of one of the identified survey positions to the tomogram to create a first corrected tomogram, applying the set of tomogram correction data of another one of the identified survey positions to the tomogram to create a second corrected tomogram and interpolating the corrected form from the first and second corrected tomograms and said relative distances.

According to another aspect, the invention provides a method of creating an error correction model for tomograms taken by a tomograph, the method comprising capturing tomograms of a calibration object, having known or deduced physical features, at a set of survey positions along an imaging path of the tomograph, and determining for each survey position a set of tomogram correction data for tomograms captured at that position on the path by comparing one or more tomograms captured at that position with the expected appearance of the known or deduced physical features in tomograms captured at that position.

The invention also relates to apparatus for creating an error correction model for tomograms taken by a tomograph, the apparatus comprising means for receiving tomograms of a calibration object, having known or deduced physical features, at a set of survey positions along an imaging path of the tomograph, and means for determining for each survey position a set of tomogram correction data for tomograms captured at that position on the path by comparing one or more tomograms captured at that position with the expected appearance of the known or deduced physical features in a tomogram captured at that position.

Thus, the invention provides a new way of creating an error correction model for tomograms.

In certain embodiments, the calibration object comprises a body in which a number of passages are formed and the determination of a set of tomogram correction data for a survey position comprises assessing the appearance of said passages in a tomogram captured at that survey position. In embodiments of this kind, the passages may be arranged in a pattern such that the determination of a set of tomogram correction data for a survey position comprises locating at least some of the passages in a tomogram captured at that survey position and determining the extent to which the located passages comply with said pattern. In embodiments of this kind, the pattern may comprise concentric circles of parallel passages. In other embodiments, the calibration object comprises a number of elongate members, such as rods, tubes or bars, that serve the same purpose as the aforementioned passages.

According to a third aspect, the invention provides a phantom for calibrating a tomograph, the phantom comprising a body in which is formed a set of at least one imaging fluid receptacles.

If one considers such a receptacle, the imaging fluid conforms to the contours of the receptacle, and it is these contours that will register in tomograms. Since the receptacle is formed in the body, its contours are relatively stable in terms of their position relative to one another, to the contours of other imaging fluid receptacles and to the phantom itself. This can lead to greater accuracy in calibration performed using this sort of phantom, as compared to, say, the case where the calibration contours to be imaged are provided by an assembly of rods or bars that might be more prone to warping or shifting relative to one another depending on envirorunental conditions or age.

In certain embodiments, the phantom comprises a plurality of parallel passages. These passages can be arranged in a known pattern. These passages may for example have circular cross section. These passages may for example have uniform cross section and the same cross section as one another.

In certain embodiments, the phantom may comprise mounting means for fixing the phantom into a tomograph. This mounting means may comprise a kinematic joint that permits the receptacle-containing body to be orientated only in a group of predefined orientations, each orientation intended to match a different imaging path of a tomograph that is to be calibrated.

In certain embodiments, the phantom may comprise compensating means for accommodating change in volume of imaging fluid sealed within the phantom.

The invention also extends to a method of making a medical diagnosis based at least in part on a tomogram or polytomograph that has been corrected using the present invention.

The invention also extends to a method of planning and/or performing a surgical procedure based at least in part on a tomogram or polytomograph that has been corrected using the present invention. For example, this may involve planning the position to which an electrode, probe or catheter is to be inserted into a body part such as a human brain, as seen in the tomogram or polytomograph. And/or it may involve inserting an electrode, probe or catheter under guidance from a tomogram or polytomograph which shows the position in real time.

The invention also extends to a method of planning the delivery of a medical treatment based at least in part on a tomogram or polytomograph that has been corrected using the present invention.

According to yet another aspect, the invention provides means for kinematically mounting a calibration object into a tomograph.

The invention also extends to programs for causing data processing equipment to carry out the tomogram correction and/or tomograph error modelling techniques to which the invention in part relates.

The invention may be used with various kinds of tomograph, such as MRI scanners and CT scanners. An imaging path that is calibrated using the invention may take various forms. For example, the imaging path could be a series of rotations about an axis with the survey and capture positions being particular rotational positions about that axis.

### BRIEF DESCRIPTION OF THE DRAWINGS

By way of example only, certain embodiments of the invention will now be described by reference to the accompanying drawings, in which:

FIG. 1 schematically illustrates an imaging path of a first type of tomograph;

FIG. 2 schematically illustrates an imaging path of a second type of tomograph;

FIG. 3 is an exploded view of an MRI phantom;

FIG. 4 schematically illustrates a desk top computer;

FIGS. 5a and 5b provide a flow chart of an error map creation algorithm;

FIG. 6 is a flow chart of a tomogram correction algorithm;

FIG. 7 is a flow chart of another tomogram correction algorithm;

FIG. 8 is a view of a component of the phantom of FIG. 3; and

FIG. 9 is a another view of the component of FIG. 8;

FIG. 10 is an isometric view of a schematic representation of a variant of the component shown in FIG. 8:

FIG. 11 is a view of an end face of the component shown in FIG. 10;

FIG. 12 is a cross-sectional view taken on line A-A of FIG. 11; and

FIG. 13 is a cross-sectional view taken on line B-B of FIG. 12.

### DETAILED DESCRIPTION

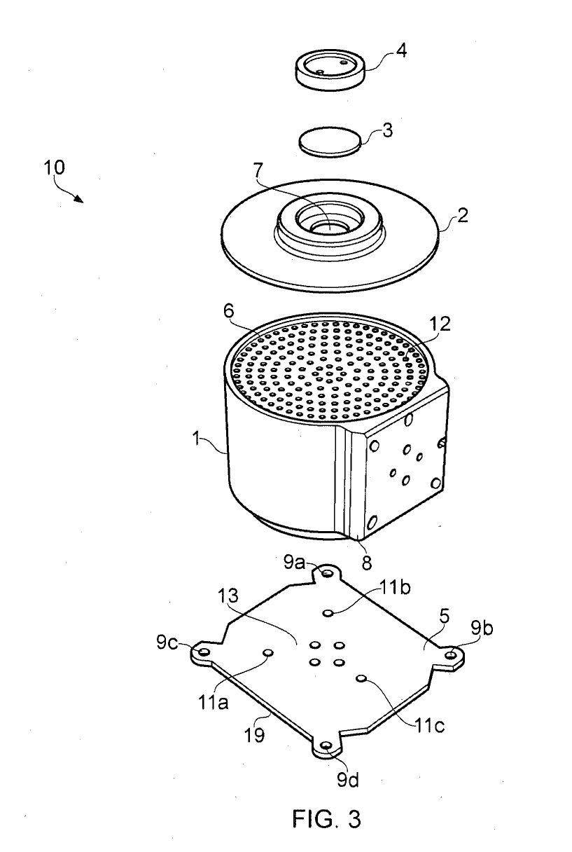

FIG. 3 shows an exploded view of a phantom 10 for use in calibrating images produced by an MRI scanner. The phantom 10 comprises a block 1 of plastics material, a lid 2, a flexible diaphragm 3, a cap 4 and a base plate 5. The block 1 is largely cylindrical but at one point the curved surface extends into a plinth 8

A series of elongate passages in the form of blind bores, e.g. 12, have been drilled into an end face of the block 1. The end face into which the bores extend is shown more clearly in FIG. 8. The bores all extend to the same depth and all have the same radius. As can be seen most clearly in FIG. 8, the bores are arranged in a pattern of concentric circles around a central one of their number, labelled 14. The surface in which the bores are formed is recessed slightly, such that a raised lip 6 is defined around this surface.

In use, the lid 2 is sealed onto the edge of the lip 6 thereby defining a cavity beneath the lid that is in fluid communication with all of the bores. The lid has a central aperture 7 through which this cavity and the bores can be filled with an imaging liquid which will conform to the contours of the walls of the bores and show up with high contrast in MRI tomograms. Once the bores and the cavity are full, the lid can be closed with the flexible diaphragm 3, which is held in place by the cap 4.

The flexible diaphragm 3 is provided to accommodate changes in volume of the imaging fluid within the phantom 10 due to temperature or air pressure changes (e.g. during air transit) whilst resisting ingress of air to, or seepage of imaging fluid from, the cavity or bores. Thus, air or other gas is excluded from the bores of the phantom. To assist in the exclusion of air, the imaging liquid contains a surfactant which aids the removal of air bubbles on the surfaces of the cavity or the bores. For example, the imaging fluid could have the following composition:
1000 ml+/−5 ml of demineralised water.
1550 mg+1-1 mg of CuSO₄.9H₂O 99.9% (hydrated).
2000 mg+1-1 mg of NaCl 99.9%.
1 ml+1-0.05 ml “Merpol OJ” surfactant.

Other imaging fluids which will provide a desired contrast in MRI tomograms could be used. For example, cod liver oil provides contrast similar to brain and other bodily tissues.

The base plate 5 is to be attached to a stereotactic frame which in normal use would accommodate the head of a person to be scanned. The base plate 5 has four corner apertures 9a-d which are to receive bolts, each of which is to be tightened into an corresponding threaded hole in the bottom of a respective one of the four major rods of the stereotactic frame, thus to fix the base plate 5 temporarily to the stereotactic frame in a manner so as to close of the aperture through which in normal use would pass the neck of a person to be scanned. The base plate 5 carries on one side a trio of spherical studs 11a-c spaced around a group of apertures, generally indicated 13. The base plate is to be mounted to the stereotactic frame so that the studs 11a-c face into the space within the stereotactic frame.

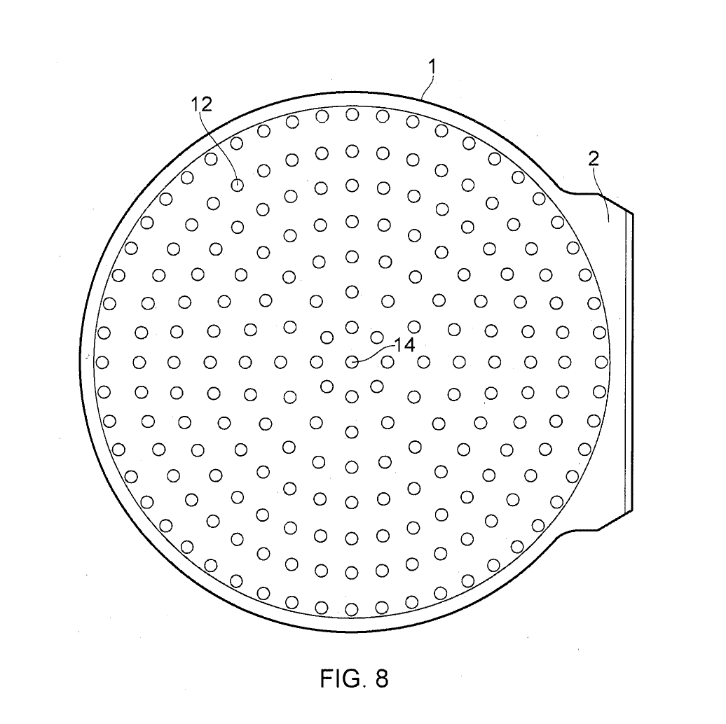

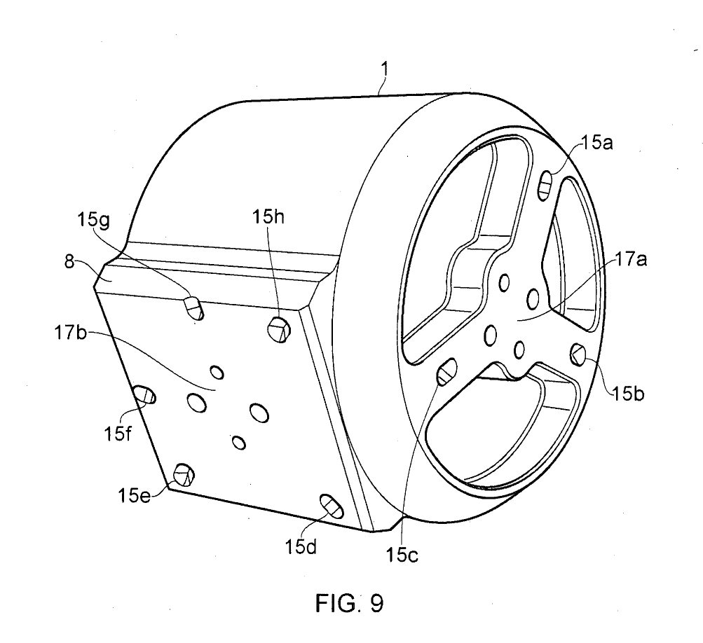

The studs 11a-c are designed to mate with corresponding slots 15a-h formed in the block 1. The slots 15a-h are most clearly seen in FIG. 9. Together, the studs 11a-c and the slots 15a-h form what is known as a kinematic joint, which allows the base plate 5 to receive the block 1 in only a predetermined number of orientations. The slots 15a-c are arranged around a group of apertures, generally indicated 17a, in one end face of the largely cylindrical block 1. The slots 15d-h are likewise arranged around a group of apertures, generally indicated 17b, in a face of the plinth 8 that lies parallel to the axis of the main cylindrical portion of the block 1.

The kinematic joint allows the liquid filled lidded block 1 to be attached to the base plate 5 in only three predetermined orientations. These are:
a) with the bores of the block 1 running perpendicular to the stud carrying face of the base plate 5.
b) with the bores of the block 1 running parallel to the stud carrying face of the base plate and perpendicular to edge 19 of the base plate.
c) with the bores of the block 1 running parallel to both the stud carrying face of the base plate and the edge 19 of the base plate.

The stereotactic frame with the phantom 10 attached is locked into a cradle on the scanning bed of an MRI scanner that is to be calibrated. The cradle receives the stereotactic frame such that the two entities fit together in a single, reproducible spatial orientation. The scanning bed receives the cradle such that the two entities fit together in a single, reproducible spatial orientation. The scanning bed loads into the MRI scanner along a predetermined track. Therefore, the result is that the body 1 is kinematically mounted relative to the magnetic field coils of the MRI scanner. Thus, when the scanning bed is loaded into the MRI scanner, the phantom is at a known, predetermined location within the MRI scanner and generates data for calibrating a specific, known space within the MRI scanner. Of course, when a patient is to be imaged, a substantially identical stereotactic frame can be fitted to the patient, and that frame can then be mounted in the cradle. Thus, the part of the patient that is to be imaged becomes co-incident with the space that was calibrated using the phantom 10. Moreover, the cradle can of course be removed from the bed and remounted as and when required, in the knowledge that its spatial relationship with the calibrated space will be restored.

In each of above-mentioned orientations a) to c), the bores of the block 1 run parallel to a different one of the imaging paths of the MRI scanner that is to be calibrated. Orientation a) is achieved by mating the studs 11a-c with slots 15a-c and securing the phantom 10 to the base plate 5 by tightening bolts through apertures 13 and into apertures 17a. Orientation b) is achieved by mating the studs 11a-c with slots 15d, e, g and tightening bolts through apertures 13 and into apertures 17b. Orientation c) is achieved by mating the studs 11a-c with slots 15d,f,h and again tightening bolts through apertures 13 and into apertures 17b.

With the three orientations a) to c), the phantom 10 can be aligned for calibration of tomograms taken on three orthogonal imaging paths, corresponding for example to tomograms in axial, coronal and sagittal planes of a patient's body. Alternatively, however, the phantom can be aligned for calibration of tomograms taken on an oblique plane, if required by the surgeon or other medical practitioner.

The physical dimensions of the bores and their spatial relationship to one another are measured to high accuracy using a metrology tool such as a Renishaw equipped co-ordinate measuring machine. At each of a series of depths into the phantom 10, the metrology tool measures the perimeter of each bore. Using known mathematical techniques, such a perimeter can be used to calculate a position for the centre of its respective bore at the depth to which the perimeter relates. That is to say, for each of a series of bore depths, the perimeter measurements can be used to produce a set of positions for the all bore centres. In each of these sets, the positions of the bore centres are specified relative to an origin which is set at the position of the centre of the central bore 14. The bore centres as measured by the metrology tool will hereinafter be referred to as “physically measured centres” (PMCs) to distinguish them from bore centres deduced by analysing an MRI tomogram. Bore centres deduced by analysing an MRI tomogram will hereinafter be called “tomogram estimated centres” (TECs). The PMCs in each set fall into concentric circles and within each circle the PMCs are indexed commencing with the PMC at the top of the circle and proceeding anticlockwise around the circle. The sets of PMCs, together with the depths to which they relate, constitute a “map” of the phantom 10 that will be used later in the calibration of tomograms.

Alternatively, the PMCs could be measured in other ways. Or it is possible simply to use nominal coordinates of the PMCs taken from the design data of the phantom, assuming it to be manufactured within appropriate tolerances. In this case, a coordinate measuring machine could be used to check that the bores are indeed within tolerance.

In use, the phantom 10, filled with the aforementioned imaging fluid, is fitted into the scanning bed of an MRI scanner to be calibrated with the bores aligned with an imaging path (axial, coronal, sagittal or oblique) whose tomograms are to be calibrated. Hereinafter, this imaging path shall be referred to as the imaging path under test. The scanning bed is then moved into the MRI scanner until the phantom 10 is positioned in the region of the MRI scanner where imaging is performed and a series of tomograms of the phantom 10 are taken, each at a different position along the imaging path under test. Each of these tomograms is an image of a 2D plane within the phantom at a different position along the imaging path under test and contains an impression of a cross section through the phantom 10 in a plane perpendicular to the length of the bores. Therefore, if the scanner were operating without distortion, each of the tomograms would show a pattern of circular discs arranged into concentric rings around a central disc. However, due to distortion in the tomograms, the pattern does not appear quite true.

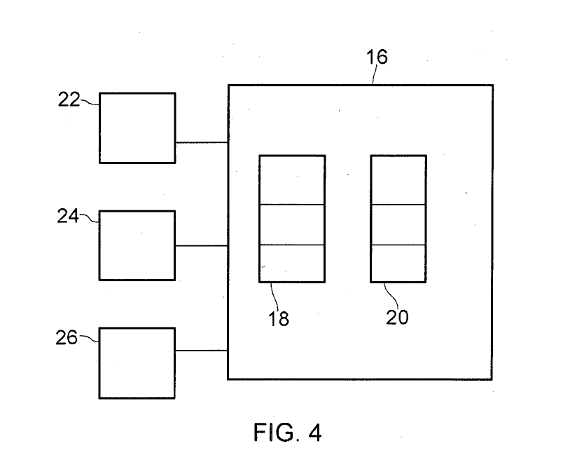

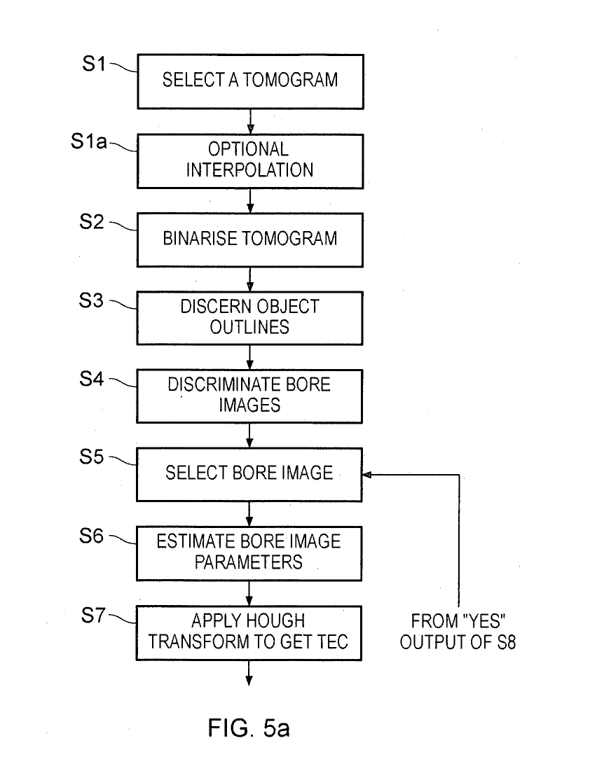

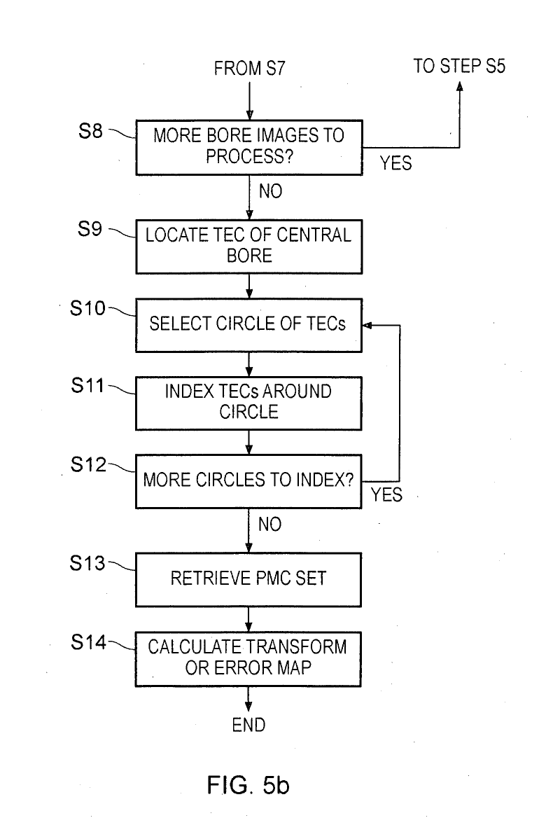

The tomograms are then supplied to a standard desk top computer 16, as shown in FIG. 4. The computer 16 comprises amongst other things the usual interconnected arrangement of memory devices 18, data processors 20, a display screen 22, a keyboard 24 and a mouse 26. The map of the phantom 10 that was produced (by the metrology tool or otherwise) is also loaded into the computer 16. The computer 16 then uses the algorithm outlined in FIG. 5 in order to produce for each tomogram a respective 2D error map, as will now be described.

The algorithm commences with step S1 in which one of the 2D tomograms is selected for processing.

In step S1a, interpolation is, if necessary, performed on the selected tomogram. For example, if the image size is less than 512×512 pixels, it may be resized so that it is 512×512 pixels. This enables features to be found on low resolution images. The image may be normalised to greyscale values between 0 and 255, so that all images analysed have the same range of values.

In step S2, the tomogram is converted from a greyscale image into a binary image. One way to do this is by using a threshold such as 20% of the maximum pixel value in the tomogram.

Alternatively, for better results, it is possible to obtain a histogram of the image and find the peaks within it. If two distinct peaks are found, then remove the data that is greater than the last peak by setting those pixels above the peak value to the greyscale value at that peak. The binary image can be obtained by thresholding based on the mean value of the new data.

Otherwise, one can remove lower and upper outliers in the histogram by removing data below the value (mean±standard deviation) and above the value (mean+(2×standard deviation)). Concentrating on the image that has the outliers thus removed, use the (mean±standard deviation) of the new data as the binary threshold.

Such threshold levels have been found to provide a good contrast between the image of the fluid charged bores and the body of the phantom and also eliminates ghost images of the fluid charged phantom that might appear in the tomogram.

In step S3, the well known MATLAB® function bwboundaries is applied to the binary image to detect the outlines of objects present in the binary image.

In step S4, any outline whose size is too small or too large to be a bore is rejected. For example, based on the known bore radius, outlines which are less than ¼ of the expected area and greater than 4 times the expected area of a bore are rejected. Next, a roundness metric is computed for each outline. This is the ratio between the perimeter of the outline and its area, which is given by

$$\frac{4 π \cdot Area}{{Perimeter}^{2}} .$$

This will be 1 if a perfect circle and less than 1 for other objects. An appropriate tolerance is used to determine if the outline is a bore.

In step S5, one of the outlines that is a bore image is selected.

In step S6, the centre of the selected outline is estimated. Typically, this is achieved by determining the width and height of the selected outline, then determining the pixel that lies at the midpoints of the width and height.

In step S7, a region of interest (ROI) is defined in the original greyscale tomogram. The ROI is centred on the estimated centre determined in step S6 and encompasses slightly more than the area enclosed by the outline selected in step S5. The well known Hough transform is then applied to the ROI of the greyscale image. The Hough transform produces a refined value for the centre of the bore image, which position is taken as the tomogram estimated centre (TEC) of the bore image. Other methods can be used instead of the Hough transform, e.g. a correlation mask.

In step S8, it is determined whether there remain any bore images for which TECs have not been calculated using the Hough transform. If there are, then the algorithm returns to step S5 and another bore image is selected. If there are not, then the algorithm moves on to step S9.

In steps S9-S12, the set of TECs found by the Hough transform is indexed.

In step S9, the TEC corresponding to the central bore 14 in the phantom 10 is located. The phantom 10 may be located in the MRI scanner such that this TEC is the one that lies the closest to the middle of the tomogram. This TEC is then deemed to be the “central marker”. Each concentric circle of TECs lying around the determined centre of bore 14 is then treated in turn.

In step S10, a concentric circle of TECs is selected.

In step S11, for each TEC on the circle, the arctangent of the line extending from the central marker to the TEC in question is calculated. The arctangent values are then used to index the TECs on the circle in an anticlockwise direction around the circle with the TEC at the top of the circle being indexed as the first TEC on the circle.

In step S12, it is determined whether there is another concentric circle of TECs to be indexed. If there is, then the algorithm returns to step S10. Otherwise, the algorithm proceeds to step S13.

The tomogram for which the indexed set of TECs has been produced is an image lying in a plane perpendicular to the direction in which the bores of the phantom 10 extend. This plane lies a certain depth into the bores as measured from the face of the phantom 10 in which the bores were drilled. In step S13, the set of PMCs that corresponds to this depth is retrieved and the central marker of the set of TECs is made co-incident with the PMC in the retrieved set that relates to the central bore 14. Thus, the retrieved set of PMCs and the set of TECs are aligned about a common origin.

In step S14, the well known MATLAB® function cp2tform is then used to create a transform relating the set of TECs to the retrieved set of PMCs. Briefly, cp2tform operates to create a mathematical transform that will transform a set of control points in a first image into a set of control points in another image. In the present circumstances, the two sets of control points that the cp2tform is used to link are the set of TECs and the retrieved set of PMCs. A variant of cp2tform that produces a polynomial transformation is used. The hi-linear transform produced is hereinafter referred to as an error map. It is a 2D model for correcting a 2D tomogram at a given position along the imaging path. Other non-linear transforms could be used, e.g. bi-cubic or nearest neighbour.

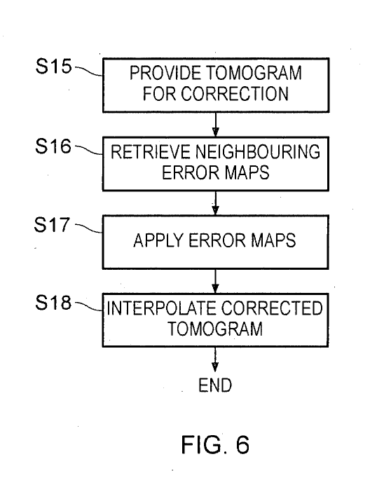

The algorithm of FIG. 5 is performed for each tomogram in the polytomograph to produce a set of 2D error maps, which together are regarded as an error model of the imaging path that has been tested using the phantom 10. The correction of a tomogram using such an error model is carried out using the algorithm of FIG. 6, as will now be described.

In step S15, a tomogram is selected for correction, hereinafter called the “target tomogram”. The target tomogram lies at a capture position along an imaging path of the tomograph.

In step S16, from within the error model of that imaging path, the two error maps that neighbour the target tomogram on the imaging path are retrieved. One of the retrieved error maps lies upstream on the imaging path relative to the target tomogram and shall therefore be referred to as the upstream error map. The other one of the retrieved error maps lies downstream on the imaging path relative to the target tomogram and shall therefore be referred to as the downstream error map.

In step S17, two modified versions of the target tomogram are created. The transform that is the upstream error map is applied to the target tomogram using the well known MATLAB® function imtransform in order to create a first modified tomogram.

Likewise, the transform that is the downstream error map is applied to the target tomogram S15 using imtrans form in order to create a second modified tomogram.

In step S18, a corrected tomogram for the position on the imaging path where the target tomogram lies is interpolated from the first and second modified tomograms. Each pixel in the corrected tomogram is determined as a weighted average of its corresponding pixels in the first and second modified tomograms. These weights are determined by the relative distances from the imaging path position where the target tomogram lies to the imaging path positions where the upstream and downstream error maps lie so as to bias the average in favour of the one of the upstream and downstream error maps that lies closest to the position of the target tomogram on the imaging path. A linear weighting process will now be described. Consider the case where the upstream and downstream error maps lie distances dᵤ and d_{d}, respectively, from the target tomogram on the imaging path. Consider that for a particular pixel position in the corrected tomogram, the corresponding greyscale values in the first (downstream) and second (upstream) modified tomograms are g₁ and g₂, respectively. The weighted average for the pixel of the corrected tomogram is then calculated as:

$$\hat{g} = {g}_{1} + \frac{( {g}_{2} - {g}_{1} ) {d}_{d}}{{d}_{u} + {d}_{d}}$$

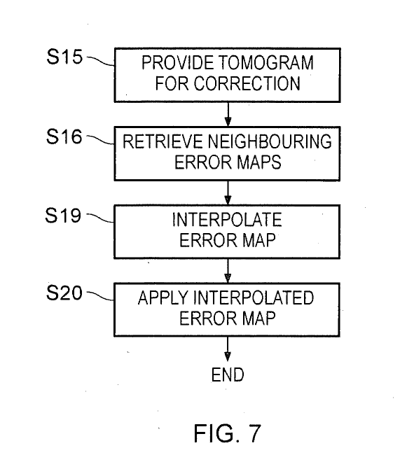

FIG. 7 provides an alternative way of employing the error maps. In FIG. 7, the steps S15 and S16 from the algorithm of FIG. 6 are re-used. Then, in step S19, the transforms that are the upstream and downstream error maps are used to create a transform for the imaging path capture position to which the target tomogram belongs. This is achieved by creating a weighted average of the two transforms using dᵤ and d_{d} in the manner used in the FIG. 6 algorithm. The resulting transform is then applied to the tomogram that is to be corrected using the imtransform function in step S20.

The algorithms described by reference to FIGS. 5, 6 and 7 can be executed by suitable data processing hardware, such as the desktop computer 16 of FIG. 4.

As described so far, just the two nearest neighbouring 2D error maps are used in the correction of the target tomogram. It will be apparent to the skilled person how a more complex interpolation algorithm could be constructed to use in addition more distant error maps in the interpolation process, e.g. using non-linear data fitting. Indeed, such data fitting techniques could extrapolate from error maps on only one side of the target tomogram, especially if the target is at the edge of the set of error maps produced from the phantom. For such a target at an edge, however, for simplicity we prefer to transform it using just one error map which is the nearest.

Similarly, for areas outside the volume of the phantom, it is possible to use data fitting techniques to extrapolate within the plane of a 2D error map.

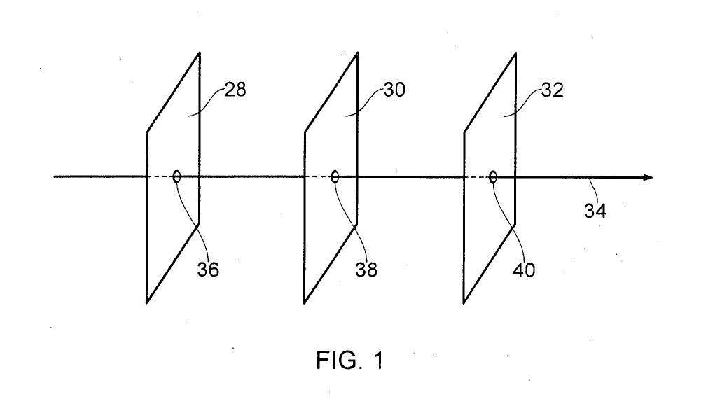

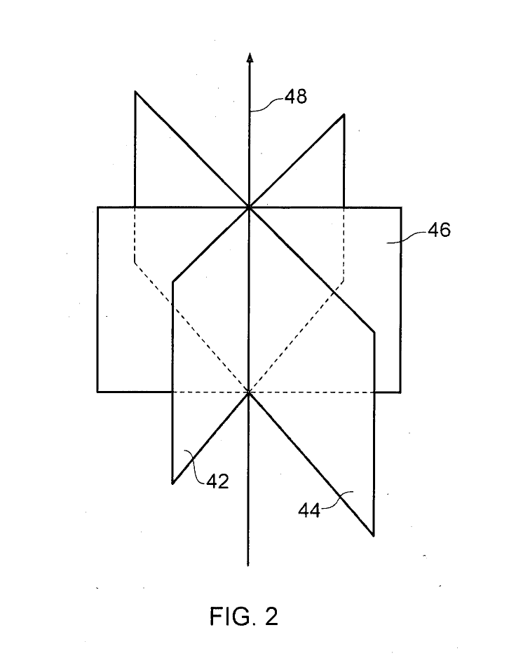

The above description and the algorithms of FIGS. 5-7 have related to an MRI scanner, where the tomogram slices are as shown in FIG. 1. However, they are equally applicable to a CT scanner, and the tomogram slices may be as shown in FIG. 2.

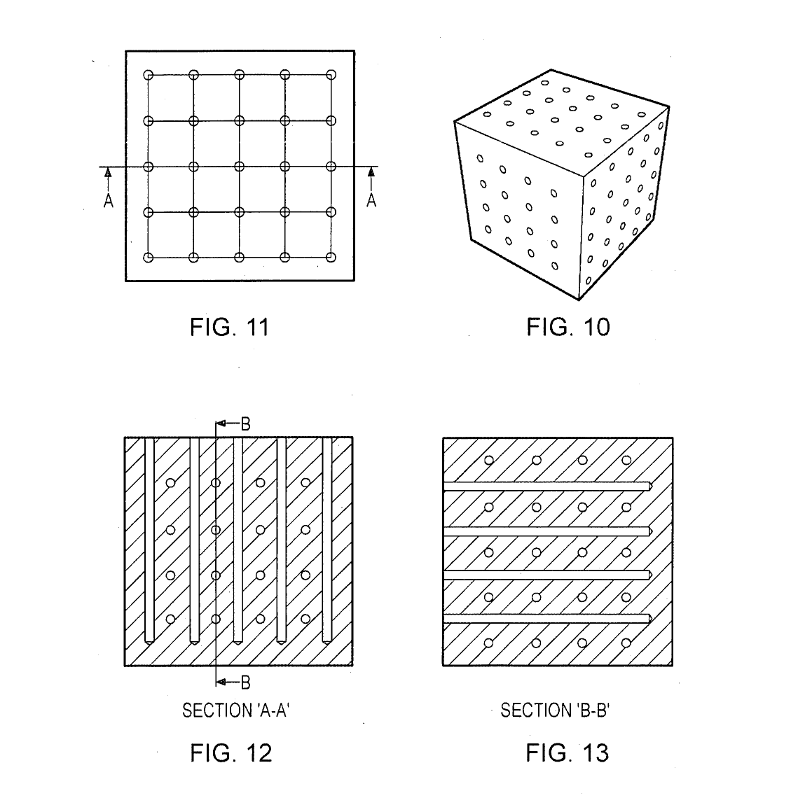

Various other modifications to the technology described herein can be conceived without departing from the scope of the present invention. For example:
The phantom could be made of a ceramic material.
The phantom could be manufactured with high precision such that there is no need to use a metrology tool to map the position of its bore centres. In this situation, the positions of the bore centres as specified in its design documentation could stand in place of the PMCs in the tomograph calibration process.
The pattern of the bores in the phantom could initially be unknown to the tomograph calibration process and could be deduced by a pattern matching step. Appropriate pattern matching algorithms are known in the image analysis field.
The bores in the phantom could be of other than circular cross-section—triangular or square, for example.
The kinematic joint could be restricted to mounting the phantom 10 to the base plate 5 in a single orientation. Two or three sets of parallel passages or bores can then be provided, arranged orthogonal to each other. The bores in each set run parallel with a respective one of the MRI scanner imaging paths that is to be tested. Views of such a phantom are provided in FIGS. 10 to 13. If an oblique imaging path is to be tested, then the phantom could have a set of bores at a corresponding oblique angle.
One phantom of the type shown in FIGS. 3, 8 and 9 (i.e. with one set of parallel passages) could have a kinematic joint with slots 15d-15h which permits it to be mounted with its passages orthogonal to either the coronal or sagittal planes. A second phantom (again with one set of parallel passages) could then be provided with a kinematic joint with slots 15a-15c which allows it to be mounted with its passages orthogonal to the axial plane.
The use of kinematic joints is preferred for mounting the phantom, so that it is located at a repeatable position in the imaging path. However, non-kinematic mounts could be used if desired.

1. A method of correcting a tomogram captured at a capture position located along an imaging path of a tomograph, the method comprising:
providing a respective set of tomogram correction data for each of a plurality of survey positions along the imaging path, each set of correction data being a 2D model for correcting a 2D tomogram at that survey position,
identifying at least two of said survey positions that neighbour the capture position, and
interpolating a corrected form for the tomogram on the basis of the sets of tomogram correction data for said identified survey positions and the relative distances from the capture position to each of the identified survey positions.

2. A method according to claim 1, wherein the interpolation of said corrected form utilises tomogram correction data from only two identified survey positions, one on each side of the capture position.

3. A method according to claim 1, wherein the step of interpolating said corrected form comprises interpolating a set of tomogram correction data for the capture position and applying the interpolated set of tomogram correction data to the tomogram.

4. A method according to claim 1, wherein the step of interpolating said corrected form comprises applying the set of tomogram correction data of one of said identified survey positions to the tomogram to create a first corrected tomogram, applying the set of tomogram correction data of another one of said identified survey positions to the tomogram to create a second corrected tomogram and interpolating the corrected form from the first and second corrected tomograms and said relative distances.

5. A method of creating an error correction model for tomograms taken by a tomograph, the method comprising:
capturing tomograms of a calibration object, having known or deduced physical features, at a set of survey positions along an imaging path of the tomograph, and
determining for each survey position a set of tomogram correction data, each set of correction data being a 2D model for correcting 2D tomograms captured at that position on the path and being determined by comparing one or more tomograms captured at that position with the expected appearance of said physical features in tomograms captured at that position.

6. A method according to claim 5, wherein the calibration object comprises a body in which a number of passages are formed and the step of determining a set of tomogram correction data for a survey position comprises assessing the appearance of said passages in a tomogram captured at that survey position.

7. A method according to claim 6, wherein the passages are filled with an imaging fluid which conforms to the walls of the passages.

8. A method according to claim 6, wherein the passages are arranged in a pattern and the step of determining a set of tomogram correction data for a survey position comprises locating at least some of the passages in a tomogram captured at that survey position and determining the extent to which the located passages comply with said pattern.

9. A method according to claim 8, wherein said pattern comprises concentric circles of parallel passages.

10. A method according to claim 5, wherein the calibration object comprises a number of elongate members and the step of determining a set of tomogram correction data for a survey position comprises assessing the appearance of said members in a tomogram captured at that survey position.

11. A method according to claim 10, wherein said members are arranged in a pattern and the step of determining a set of tomogram correction data for a survey position comprises locating at least some of said members in a tomogram captured at that survey position and determining the extent to which the located members comply with said pattern.

12. A method according to claim 11, wherein said pattern comprises concentric circles of parallel elongate members.

13. A phantom for calibrating a tomograph, the phantom comprising a body in which is formed a set of at least two elongate passages, the passages forming receptacles for an imaging fluid which conforms to the walls of the passages.

14. A phantom according to claim 13, wherein said set comprises a plurality of parallel passages.

15. A phantom according to claim 14, wherein said parallel passages are arranged in a known pattern.

16. A phantom according to claim 14, wherein the passages have circular cross section.

17. A phantom according to claim 14, comprising two or three sets of parallel passages, arranged orthogonal to each other.

18. A phantom according to claim 13, wherein the passages have uniform cross section and the same cross section as one another.

19. A phantom according to claim 13, further comprising mounting means for fixing the phantom into a tomograph.

20. A phantom according to claim 19, wherein the mounting means comprises a kinematic joint that permits said body to be orientated only a group of predefined orientations, each orientation intended to match a different imaging path of the tomograph.

21. A phantom according to claim 13, further comprising compensating means for accommodating change in volume of imaging fluid sealed within the phantom.

22. Apparatus for correcting a tomogram captured at a capture position located along an imaging path of a tomograph, the apparatus comprising:
means for identifying amongst a plurality of survey positions along the imaging path at least two survey positions that neighbour the capture position,
each survey position having a respective set of tomogram correction data, each set of correction data being a 2D model for correcting a 2D tomogram at that survey position, and
means for interpolating a corrected form for the tomogram on the basis of the sets of tomogram correction data for the identified survey positions and the relative distances from the capture position to each of the identified survey positions.

23. Apparatus according to claim 22, wherein the interpolating means is arranged to interpolate said corrected form using tomogram correction data from only two identified survey positions, one on each side of the capture position.

24. Apparatus according to claim 22, wherein the interpolating means is arranged to interpolate a set of tomogram correction data for the capture position and to apply the interpolated set of tomogram correction data to the tomogram.

25. Apparatus according to claim 22, wherein the interpolating means is arranged to apply the set of tomogram correction data of one of said identified survey positions to the tomogram to create a first corrected tomogram, to apply the set of tomogram correction data of the another one of said identified survey positions to the tomogram to create a second corrected tomogram and to interpolate the corrected form from the first and second corrected tomograms and said relative distances.

26. Apparatus for creating an error correction model for tomograms taken by a tomograph, the apparatus comprising:
means for receiving tomograms of a calibration object, having known or deduced physical features, at a set of survey positions along an imaging path of the tomograph, and
means for determining for each survey position a set of tomogram correction data, each set of correction data being a 2D model for correcting 2D tomograms captured at that position on the path, by comparing one or more tomograms captured at that position with the expected appearance of said physical features in a tomogram captured at that position.

27. Apparatus according to claim 26, wherein the calibration object comprises a body in which a number of passages are formed and the means for determining a set of tomograph correction data for a survey position comprises means for assessing the appearance of said passages in a tomogram captured at that survey position.

28. Apparatus according to claim 27, wherein the passages are filled with an imaging fluid which conforms to the walls of the passages.

29. Apparatus according to claim 27, wherein the passages are arranged in a pattern and the means for determining a set of tomogram correction data for a survey position comprises means for locating at least some of the passages in a tomogram captured at that survey position and means for determining the extent to which the located passages comply with said pattern.

30. Apparatus according to claim 29, wherein said pattern comprises concentric circles of parallel passages.

31. Apparatus according to claim 26, wherein the calibration object comprises a number of elongate members and the means for determining a set of tomograph correction data for a survey position comprises means for assessing the appearance of said members in a tomogram captured at that survey position.

32. Apparatus according to claim 31, wherein said members are arranged in a pattern and the means for determining a set of tomogram correction data for a survey position comprises means for locating at least some of said members in a tomogram captured at that survey position and means for determining the extent to which the located members comply with said pattern.

33. Apparatus according to claim 32, wherein said pattern comprises concentric circles of said elongate members.

34. A method of making a medical diagnosis based at least in part on a tomogram or polytomograph that has been corrected using the method of claim 1.

35. A method of planning a surgical procedure based at least in part on a tomogram or polytomograph that has been corrected using the method of claim 1.

36. A method of planning the delivery of a medical treatment based at least in part on a tomogram or polytomograph that has been corrected using the method of claim 1.

37. A program for causing data processing equipment to carry out the method of claim 1.
